(19) United States
(12) Patent Application Publication
(10) Pub. No.: US 2016/0281383 A1
(43) Pub. Date: Sep. 29, 2016

(54) POST-INSTALLED ANCHOR, INSTALLATION METHOD THEREOF AND POST-INSTALLED ANCHOR SYSTEM

(71) Applicant: FS TECHNICAL CORPORATION, Tokyo (JP)

(72) Inventor: Shogo Fujita, Tokyo (JP)

(21) Appl. No.: 14/411,395

(22) PCT Filed: Jan. 29, 2014
(86) PCT No.: PCT/JP2014/000452

§ 371 Date: Dec. 26, 2014

(30) Foreign Application Priority Data
Aug. 13, 2013 (JP) 2013-168037
Nov. 14, 2013 (JP) 2013-236250

(51) Int. Cl. E04H 12/22; E02D 7/04; E02D 27/42; F16B 13/12

(52) U.S. Cl. CPC E04H 12/223; F16B 13/126; F16B 13/128; E02D 7/04; E02D 27/42

(57) ABSTRACT

A post-installed anchor 10 has a cylindrical body 11, a diameter expanding portion 12 continuing to a tip side of the cylindrical body 11, and a cone portion 13 expanding the diameter expanding portion 12. The diameter expanding portion 12 has a main expanding portion 21 corresponding to the diameter expanded portion 4, a base side expanding portion 22 continuing to a base side of the main expanding portion 21, and a tip side expanding portion 23 continuing to a tip side of the main expanding portion 21, a base side thin-walled portion 24 provided between the base side expanding portion 22 and the main expanding portion 21, and a tip side thin-walled portion 25 provided between the main expanding portion 21 and the tip side expanding portion 23.

### TECHNICAL FIELD

The present invention relates to a post-installed anchor which is anchored in an anchor hole perforated in a framework such as concrete, an installation method of the post-installed anchor and a post-installed anchor system.

### BACKGROUND ART

A post-installed anchor (referred as “anchor” hereinafter) has been known as this kind of post-installed anchor, which is used for fixing a suspended object such as a ceiling board on a framework such as a concrete slab (see Patent Citation 1). The anchor is driven (struck) in a specially-shaped prepared hole. The prepared hole has a main hole portion, a tapered hole portion which continues to the main hole portion and has an expanded diameter, and a straight hole portion which continues to the tapered hole portion and has a smaller diameter than the main hole portion.

The anchor has a large diameter shaft portion at a base side, a plug continuing to the large diameter shaft portion, and a sleeve mounted on the plug. The plug has a circular projection portion and a tapered surface continuing thereto, and the sleeve has a fitting groove and an expanding portion which correspond to the circular projection portion and the tapered portion. When the anchor is inserted in the prepared hole, a lower end of the expanding portion contacts on a bottom of the tapered hole portion.

In this state, when the large diameter shaft portion is driven, the tapered surface of the plug pushes the expanding portion of the sleeve open and the circular projection portion of the plug fits in the fitting groove of the sleeve. The pushed open expanding portion is pressed to contact in the tapered hole portion, thereby the sleeve is anchored in the framework. Further, the circular projection portion fitted in the fitting groove is in a retention state, and the sleeve, the plug and the large diameter shaft portion are integrated in a pullout direction.

[Citation List 1] JP-A-2008-183707

### SUMMARY OF THE INVENTION

In the above known post-installed anchor, the sleeve is a separate member from the large diameter shaft portion and the plug, and when the sleeve is driven for anchoring, it comes in the retention state in the plug at the same time. Therefore, in case that a pressure-contact state of the expanding portion on the tapered surface of the prepared hole becomes loose or a fitting state of the plug in the sleeve becomes loose due to manufacturing error of each member, pullout strength decreases and the anchor easily falls off from the prepared hole. Especially, when the anchor suffers wobbles or vibrations repetitively caused by earthquakes or the like, the anchor is prone to fall off from the prepared hole as time passes.

An advantage of the invention is to provide a post-installed anchor which can prevent the decrease of the pullout strength as time passes, an installation method thereof and a post-installed anchor system.

According to one aspect of the invention, there is provided a post-installed anchor that is anchored in an anchor hole having a diameter expanded portion formed at a predetermined depth position in a prepared hole comprising: a cylindrically-shaped cylindrical body that is inserted in the anchor hole; a diameter expanding portion that continues to a tip side of the cylindrical body; and a cone portion that expands the diameter expanding portion from an inside, the diameter expanding portion having: a main expanding portion that corresponds to the diameter expanded portion; a base side expanding portion that continues to a base side of the main expanding portion; a tip side expanding portion that continues to a tip side of the main expanding portion; and a first deformation portion that is provided at least one of positions between the base side expanding portion and the main expanding portion and between the main expanding portion and the tip side expanding portion, and that deforms prior to the main expanding portion, the base side expanding portion and the tip side expanding portion when the diameter expanding portion is expanded by the cone portion.

According to the structure, the diameter expanding portion has the main expanding portion, the base side expanding portion and the tip side expanding portion, and the main expanding portion corresponds to the diameter expanded portion of the anchor hole. Shortly, in an inserted state in the anchor hole, the main expanding portion faces the diameter expanded portion, the base side expanding portion faces a region (base side) around the diameter expanded portion of the prepared hole, and the tip side expanding portion faces a region (tip side) around the diameter expanded portion of the prepared hole. Therefore, when diameter expanding portion is expanded by driving (striking) the cone portion, the main expanding portion expands toward the diameter expanded portion, the base side expanding portion expands toward the base side region of the prepared hole, and the tip side expanding portion expands toward the tip side region of the prepared hole.

At this time, since the first deformation portion formed at one side or both sides sandwiching the main expanding portion deforms on a priority basis, the base side expanding portion and the tip side expanding portion are pressed to contact on the regions around the diameter expanded portion of the prepared hole. Simultaneously, the main expanding portion expands widely to be pressed to contact on the diameter expanded portion. Shortly, the main expanding portion is locked (pressed to contact) on the diameter expanded portion of the anchor hole spontaneously, and is anchored on the diameter expanded portion in a retention state (latched on circular stepped portions).

Further, since the base side expanding portion and the tip side expanding portion continuing to the main expanding portion are pressed to contact on regions of the prepared hole, chatter (wobble) does not occur as a whole and loosening by vibration or the like is hardly happened. Still further, since the main expanding portion can expand widely, it is not necessary to form a diameter of the main expanding portion larger than those of other portions preliminarily, thereby size difference between a diameter of the post-installed anchor and a diameter of the anchor hole can be smaller as possible. In this regard, chatter cannot easily happen.

Therefore, not only the post-installed anchor can be firmly fixed in the anchor hole, but also the chatter due to vibration or the like is restrained, which avoids decrease of pullout strength as time passes effectively.

In this case, it is preferable that the tip side expanding portion be formed to have a smaller diameter than the main expanding portion.

According to the structure, since the tip side expanding portion is formed smaller than the main expanding portion, the cone portion can be struck deeply, which expands the main expanding portion sufficiently. Therefore, even if a post-installed anchor after installation receives vibration or the like repetitively, the post-installed anchor can never be loose.

In this case, it is preferable that the base side expanding portion and the main expanding portion have a diameter as same as a diameter of the cylindrical body.

According to the structure, the cylindrical body, the base side expanding portion and the main expanding portion have a same diameter except the smallest tip side expanding portion. Therefore, the prepared hole of the anchor hole may be formed slightly larger than the cylindrical body, the base side expanding portion and the main expanding portion. For example, if the prepared hole having a larger diameter about 0.5 mm with respect to an outer diameter of the post-installed anchor is formed, the post-installed anchor can be fit to insert the anchor hole naturally. Shortly, the post-installed anchor can be anchored without chatter.

Further, it is preferable that the first deformation portion be a thin-walled portion formed by a circular groove formed on an outer peripheral surface of the diameter expanding portion.

According to the structure, the first deformation portion can be easily formed only by grinding or narrowing down the outer peripheral surface of the diameter expanding portion. A bottom floor of the circular groove is preferably formed in a semicircular shape in cross section so as not to concentrate stress.

Further, it is preferable that the first deformation portions be provided at two positions between the base side expanding portion and the main expanding portion and between the main expanding portion and the tip side expanding portion.

According to the structure, since the first deformation portions are provided at both sides of the main expanding portion in an axial direction, the main expanding portion can be expanded widely and easily by driving etc. the cone portion. This allows the main expanding portion to be pressed to contact on the diameter expanded portion of the anchor hole surely.

In this case, it is preferable that the first deformation portions at the two positions be formed to have same volume.

According to the structure, the first deformation portions at the two positions can be deformed in a same condition physically. Therefore, the main expanding portion can be evenly expanded along the diameter expanded portion.

In these cases, it is preferable that the diameter expanding portion further have a second deformation portion that is provided between the cylindrical body and the base side expanding portion and deforms prior to the cylindrical body and the base side expanding portion when the diameter expanding portion is expanded by the cone portion.

According to the structure, since the second deformation portion is provided between the cylindrical body and the base side expanding portion, the base side expanding portion can be expanded by the cone portion easily. In other words, the base side expanding portion can be pressed to contact on a base side region of the prepared hole for certain.

While, it is preferable that a plurality of slits extending from a tip to the second deformation portion be provided.

According to the structure, expanding formation of the diameter expanding portion can be controlled freely by the plurality of slits and the plurality of deformation portions.

Further, it is preferable that the post-installed anchor be a cone driving type where the cone portion is driven in the cylindrical body, an inner peripheral surface of the diameter expanding portion be formed in a tapered shape tapering off the tip, and the cone portion be formed in a size that is suitable for being driven to a position at the main expanding portion.

According to the structure, when the cone portion is struck, it reaches a position at the main expanding portion to expand the main expanding portion. Further, reaction force by pressure contact of the base side expanding portion acts to embrace the cone portion. Thus, the driven cone portion can be restrained from falling off due to vibration or the like.

In this case, it is preferable that the cone portion have a tapered portion that is formed in a tapered shape tapering off to the tip and a straight portion that continues to the base side of the tapered portion and has a same diameter as a base side of the tapered portion.

Likewise, it is preferable that the cone portion have a tapered portion that is formed in a tapered shape tapering off to the tip and an inverse tapered portion that continues to the base side of the tapered portion and is formed in a tapered shape tapering off to the base.

According to these structures, when the reaction force by pressure contact of the base side expanding portion acts to embrace the base side of the cone portion, an inner peripheral surface of the base side expanding portion slightly deforms along a shape of a base of the cone portion. Therefore, the driven cone portion can be prevented from falling off due to vibration or the like.

Likewise, it is preferable that the cone portion be formed in either a spherical shape or a drum shape.

According to the structure, the main expanding portion can be expanded efficiently by driving the cone portion. Further, the reaction force of the diameter expanding portion acts embrace the cone portion to prevent the cone portion from falling off.

Further, it is preferable that the post-installed anchor be a main body driving type where the cylindrical body is driven with respect to the cone portion, the cone portion has a cone portion main body that expands the diameter expanding portion and a struck portion that continues to the cone portion main body, is formed to have a smaller diameter than the cone portion main body, and is butted on a bottom of the anchor hole, an inner peripheral surface of the diameter expanding portion is formed in a tapered shape tapering off to a base, and the cone portion main body is formed in a size that is suitable for being driven to a position at the main expanding portion.

According to the structure, the cone portion main body reaches the position at the main expanding position by striking the cylindrical body to expand the main expanding portion. Further, the reaction force by pressure contact of the tip side expanding portion acts to embrace the cone portion main body. Thus, the struck cone portion can be restrained from falling off due to vibration or the like.

In this case, it is preferable that the cone portion main body have a tapered portion that is formed in a tapered shape tapering off toward the cylindrical body and a straight portion that continues to a base side of the tapered portion and has a same diameter as a base side of the tapered portion.

Likewise, it is preferable that the cone portion main body have a tapered portion that is formed in a tapered shape tapering off toward the cylindrical body and an inverse tapered portion that continues to a base side of the tapered portion and is formed in a tapered shape tapering off to the base.

According to these cases, when the reaction force by pressure contact of the tip side expanding portion acts to embrace the base side of the cone portion main body, the inner peripheral surface of the tip side expanding portion slightly deforms along the shape of the base of the cone portion main body. Therefore, the struck cone portion can be prevented from falling off.

Likewise, it is preferable that the cone portion main body be formed in either a spherical shape or a drum shape.

According to the structure, the main expanding portion can be expanded efficiently by striking the cone portion. Further, the reaction force of the diameter expanding portion acts to embrace the cone portion, which prevents the cone portion from falling off.

An installation method of the post-installed anchor of the invention is an installation method of above mentioned post-installation anchor and executes steps of: perforating the prepared hole; expanding to form the diameter expanded portion in the prepared hole; inserting the post-installed anchor in the anchor hole; and anchoring to expand the diameter expanding portion by the cone portion.

According to the method, when the diameter expanding portion is expanded (anchored), the main expanding portion is locked (pressed to contact) on the diameter expanded portion of the anchor hole naturally. At the same time, the base side expanding portion and the tip side expanding portion are also pressed to contact on regions of the prepared hole around the diameter expanded portion. Especially, since the main expanding portion is in the retention state on circular stepped portions of the diameter expanded portion, the post-installed anchor cannot fall off even the post-installed anchor suffers loosening due to vibration or the like. Further, since the main expanding portion can be expanded widely, it is not necessary to form the main expanding portion having a larger diameter than other portions, which allows size difference between a diameter of the post-installed anchor and a diameter of the anchor hole to be as small as possible. Also in this regard, a structure which seldom suffers the chatter can be achieved. Therefore, not only the post-installed anchor can be firmly fixed in the anchor hole, but also decrease of the pullout strength as time passes can be avoided effectively.

In this case, it is preferable that a step of injecting an adhesive in the anchor hole be executed between the expanding and the inserting.

According to the method, the post-installed anchor can be fixed in the anchor hole not only mechanically but also by the adhesive. Therefore, the post-installed anchor can be firmly fixed (immovable) in the anchor hole and the decrease of the pullout strength as time passes can be avoided effectively.

A post-installed anchor system of the invention has the post-installed anchor described above; and a diameter expanding drill bit that has a blade portion at a tip grinding the anchor hole to grind the diameter expanded portion, wherein, in the axial direction, the blade portion is formed longer than the main expanding portion, and a distance from a tip of the post-installed anchor to an intermediate position of the main expanding portion is set as same as a distance from a tip of the diameter expanding drill bit to an intermediate position of the blade portion.

According to the structure, it is possible to correspond the position of the diameter expanded portion formed in the anchor hole by the diameter expansion drill bit with the position of the main expanding portion of the post-installed anchor anchored in the anchor hole. Therefore, the main expanding portion of the post-installed anchor anchored in the anchor hole is anchored (pressed to contact) on the diameter expanded portion and is in the retention state on portions of the circular stepped portions of the diameter expanded portion. Thus, even the post-installed anchor suffers the loosening due to vibration or the like, it never falls off. Therefore, not only the post-installed anchor can be firmly fixed in the anchor hole, but also the decrease of the pullout strength as time passes can be prevented effectively.

### BRIEF DESCRIPTION OF THE DRAWINGS

FIG. 1 is a cross sectional view of an anchor hole in which a post-installed anchor is anchored.

FIG. 2A is a front elevation view and FIG. 2B is a bottom view of the post-installed anchor according to the first embodiment.

FIG. 3 is a cross sectional view of the post-installed anchor according to the first embodiment.

FIGS. 4A and 4B are structure views of a cone portion of the post-installed anchor.

FIGS. 5A to 5C are structure views of the cone portion according to a modification.

FIGS. 6A to 6C are cross sectional views illustrating an installation procedure of the post-installation anchor according to the first embodiment.

FIGS. 7D and 7E are cross sectional views illustrating the installation procedure of the post-installation anchor according to the first embodiment.

FIG. 8A is a front elevation view and FIG. 8B is a cross sectional view of the post-installed anchor according to the second embodiment.

FIG. 9A is a cross sectional view of the post-installed anchor and FIG. 9B is a cross sectional view of the driven post-installed anchor according to the third embodiment.

### DETAILED DESCRIPTION OF THE INVENTION

Hereinafter, a post-installed anchor, an installation method thereof and a post-installed anchor system according to one embodiment of the invention will be explained with reference to accompanying drawings. The post-installed anchor is, as it is called, a metallic expansion anchor which is provided to support a structure on a concrete framework such as a slab, an external wall and an internal wall. Especially, the post-installed anchor of the embodiment is used for antiseismic reinforcement for buildings and facility device setting, and can prevent decrease of pullout strength as time passes caused by vibrations due to earthquakes or the like by cooperating with a specially-shaped anchor hole. Further, the post-installed anchor system is formed by the post-installed anchor and a diameter expanding drill bit for forming the specially-shaped anchor hole in combination. First of all, the specially-shaped anchor hole will be briefly explained before an explanation of the post-installed anchor.

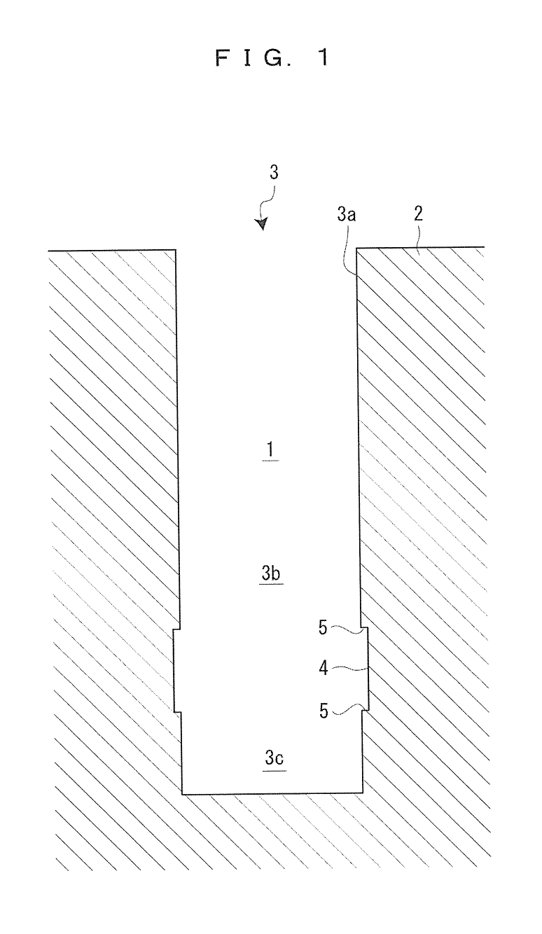

FIG. 1 illustrates the anchor hole formed in a framework such as concrete. As illustrated in FIG. 1, an anchor hole 1 has a straight-shaped prepared hole portion (prepared hole) perforated in a framework 2, and a diameter expanded portion 4 formed to have a larger diameter than the prepared hole portion 3 at a deeper portion (tip portion) of the prepared hole portion 3. In this case, the diameter expanded portion 4 is formed by a cylindrical portion which projects outwardly from the prepared hole portion 3 having two circular stepped portions 5. Further, the prepared hole portion 3 has a long opening side hole portion 3b at an opening portion 3a side and a short bottom side hole portion 3c at a bottom side having the diameter expanded portion 4 therebetween. Though details will be explained later, the prepared hole portion 3 and the diameter expanded portion 4 are formed by different drill bits.

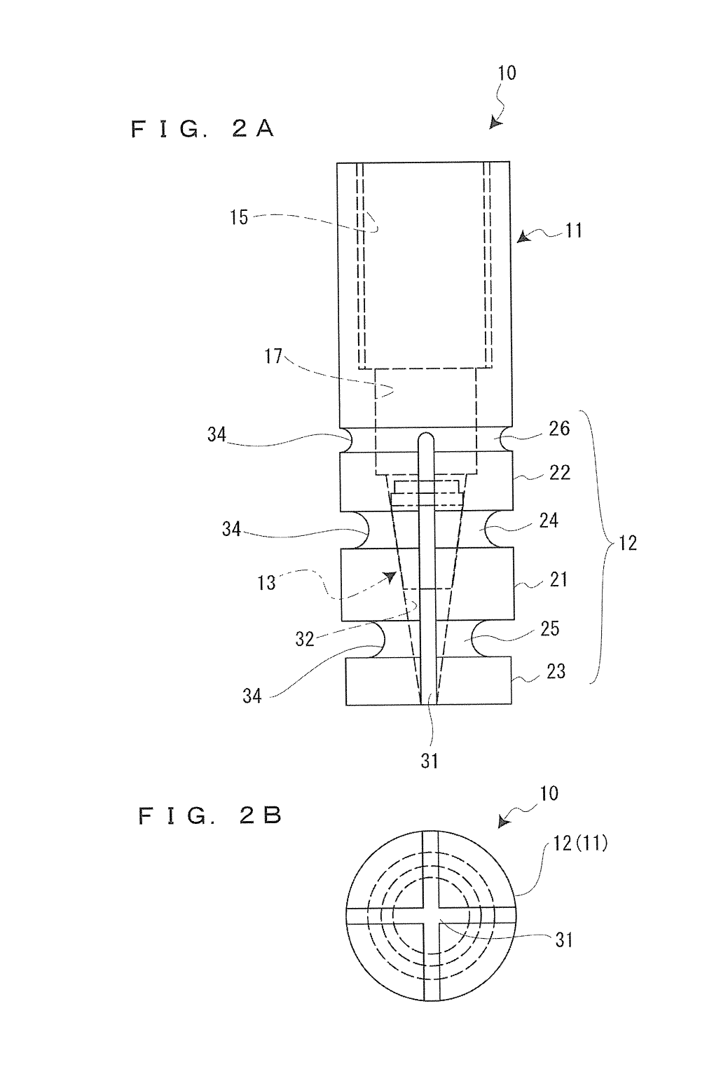

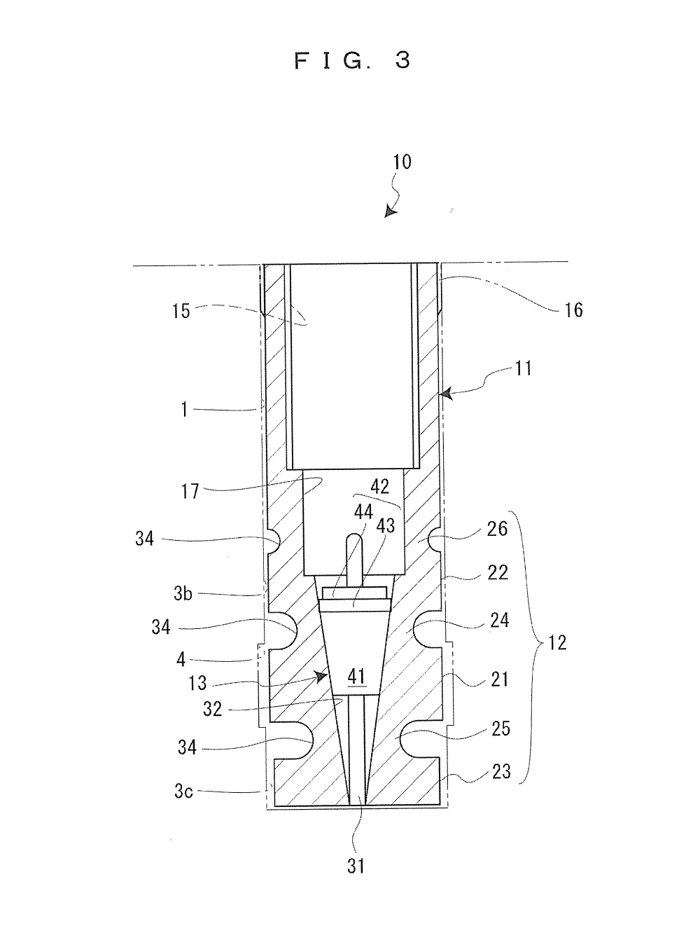

FIG. 2A is a front elevation view and FIG. 2B is a bottom view of the post-installed anchor according to the first embodiment. FIG. 3 is a cross sectional view thereof. As illustrated in FIG. 2A to FIG. 3, a post-installed anchor 10 is, as it is called, an internal cone driving type anchor and has a cylindrically-shaped cylindrical body 11 inserted in the anchor hole 1, a diameter expanding portion 12 continuing to a tip of the cylindrical body 11, and a cone portion 13 expanding the diameter expanding portion 12 from the inside thereof. The cylindrical body 11 and the diameter expanding portion 12 are formed by soft steel, stainless steel or the like integrally. Further, the cone portion 13 is also formed by soft steel, stainless steel or the like integrally.

An internal thread portion 15 is formed on the inner surface of the cylindrical body 11, and a joint bolt (generally, a full-screw bolt) (not illustrated) such as a hanging bolt or a connecting bolt for a supported object is screwed therein. A fitting member 16 (illustrated in FIG. 3 by an imaginary line) which fits to engage with the opening portion 3a of the anchor hole may be provided on an outer peripheral surface at a base portion of the cylindrical body 11 to prevent chatter (wobble) of the anchored post-installed anchor 10.

The diameter expanding portion 12 has a main expanding portion 21 corresponding to the diameter expanded portion 4 of the anchor hole 1, a base side expanding portion 22 continuing to a base side of the main expanding portion 21 and a tip side expanding portion 23 continuing to a tip side of the main expanding portion 21. Further, the diameter expanding portion 12 has a base side thin-walled portion 24 (the first deformation portion) provided between the base side expanding portion 22 and the main expanding portion 21, a tip side thin-walled portion 25 (the first deformation portion) provided between the main expanding portion 21 and the tip side expanding portion 23 and a sub thin-walled portion 26 (the second deformation portion) provided between the cylindrical body 11 and the base side expanding portion 22. Shortly, the diameter expanding portion 12 includes, from the cylindrical body side, the sub thin-walled portion 26, the base side expanding portion 22, the base side thin-walled portion 24, the main expanding portion 21, the tip side thin-walled portion 25 and the tip side expanding portion 23 in sequence.

Further, the diameter expanding portion 12 has a plurality of slits cut from a tip thereof. In the embodiment, four slits 31 arranged equally apart in a circumferential direction are provided (see FIG. 2B), and each slit 31 extends from a tip of the tip side expanding portion 23 to a position at the sub thin-walled portion 26 in an axial direction. Not to mention, the four slits 31 promote expansion of the diameter expanding portion 12 by driving the cone portion 13. Two or three slits 31 may be provided (in either case, the slits 31 should be equally separated in the circumferential direction).

A cone reception portion 32 in a tapered shape tapering off to a tip is formed in an inner peripheral surface of the diameter expanding portion 12, and the cone portion 13 is driven (struck) in the cone reception portion 32. The cone reception portion 32 extends from the position at the sub thin-walled portion 26 to the tip of the tip side expanding portion 23. In this case, a taper of the cone reception portion 32 and a taper of the cone portion 13 are formed in a same angle. A communication hole 17 of which diameter is smaller than that of the internal thread portion 15 is formed between the cone reception portion 32 and the above internal thread portion 15.

The base end expanding portion 22, the main expanding portion 21 and the tip side expanding portion are all formed in a ring shape. The base side expanding portion 22 and the main expanding portion 21 are formed to have a same diameter as the cylindrical body 11. Further, the tip side expanding portion 23 is formed to have a slightly smaller diameter (about 0.5 mm) than the base side expanding portion 22 and the main expanding portion 21. While, in the order of length in the axial direction from the longest, the main expanding portion 21, the base side expanding portion 22 and the tip side expanding portion 23 are set, and those are formed by a size ratio such as 6:5:4. The diameter of the tip side expanding portion 23 may be formed as same as that of the main expanding portion 21 and the like.

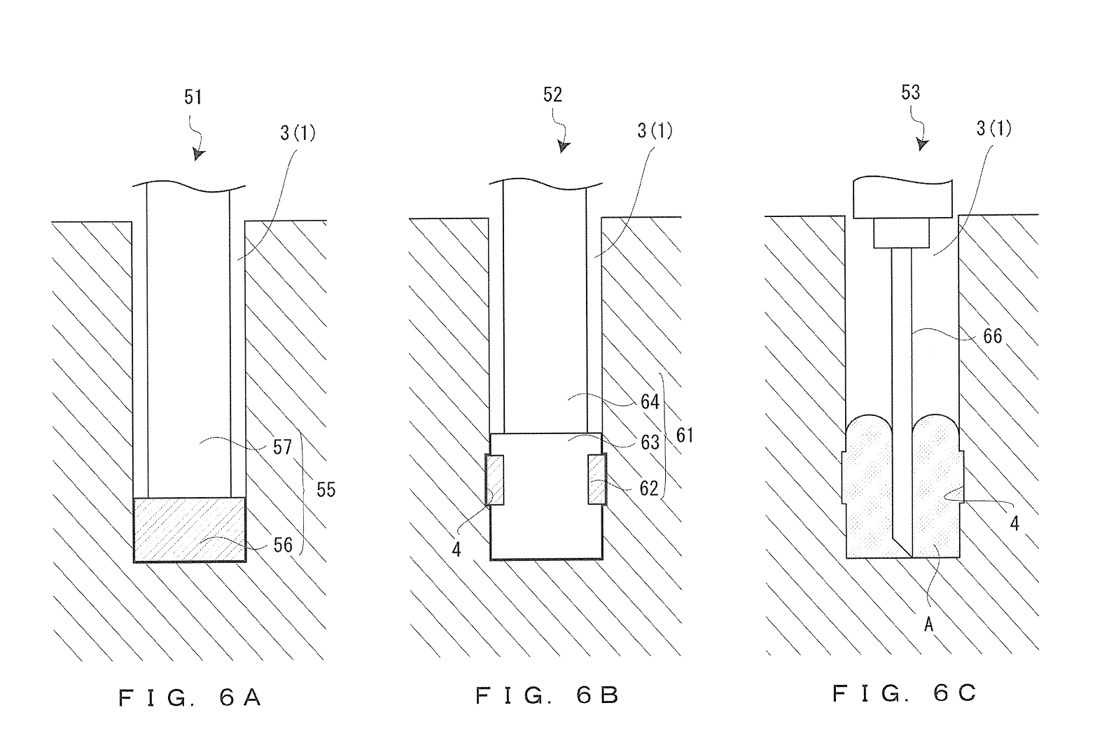

In this case, when the post-installed anchor 10 is inserted in the anchor hole 1, the main expanding portion 21 is provided to correspond to a depth position at the diameter expanded portion 4. Further, the main expanding portion 21 is formed in a size slightly shorter than the diameter expanded portion 4 in the axial direction. Though a detail will be explained later, when the cone portion 13 is struck, the tip of the tip side expanding portion 23 butts on the bottom of the anchor hole 1. While, the position of the diameter expanded portion 4 from the bottom is defined based on a relationship with a diameter expanding apparatus 52 described later (see FIG. 6B). Therefore, length of the tip side expanding portion 23 in the axial direction is designed based on the relationship with the diameter expanding apparatus 52.

The base side thin-walled portion 24 and the tip side thin-walled portion 25 are formed in size of “3” in the above size ratio. Further, the base end thin-walled portion 24 and the tip side thin-walled portion 25 are formed by a circular groove 34 formed on an outer peripheral surface of the diameter expanding portion 12. A bottom floor of the circular groove 34 is formed in a semicircular shape in cross section so as not to concentrate stress at the time of deformation. The circular groove 34 of the tip side thin-walled portion 25 is formed deeper than that of the base end thin-walled portion 24 such that the base side thin-walled portion 24 and the tip side thin-walled portion 25 facing the taper-shaped cone reception portion 32 have a same thickness. More preferably, the volume of the base end thin-walled portion 24 is set as same as that of the tip side thin-walled portion 25. Thus, the base side thin-walled portion 24 and the tip side thin-walled portion 25 are deformed under physically almost identical conditions.

Likewise, the sub thin-walled portion 26 is formed in size of “2” in the above size ratio. Also in this case, the sub thin-walled portion 26 is formed by the circular groove 34 formed on the outer peripheral surface of the diameter expanding portion 12. The sub thin-walled portion 26 is formed to have a same thickness as those of the base side thin-walled portion 24 and the tip side thin-walled portion 25.

Thus, the tip side thin-walled portion 25, the base side thin-walled portion 24 and the sub thin-walled portion 26 are formed sufficiently thinner than the tip side expanding portion 23, the main expanding portion 21 and the base side expanding portion 22. Therefore, the tip side thin-walled portion 25, the base side thin-walled portion 24 and the sub thin-walled portion 26 deform prior to the tip side expanding portion 23, the main expanding portion 21 and the base side expanding portion 22 by expanding force of the driven cone portion 13.

More specifically, the tip side thin-walled portion 25 deforms prior to the tip side expanding portion 23 and the main expanding portion 21, the base side thin-walled portion 24 deforms prior to the main expanding portion 21 and the base side expanding portion 22, and the sub thin-walled portion 26 deforms prior to the base side expanding portion 22 and the cylindrical body 11. Since the slits 31 are not formed in the cylindrical body 11, the sub thin-walled portion 26 deforms prior to the base side expanding portion 22. The main expanding portion 21 sandwiched between the wide tip side thin-walled portion 25 and the base side expanding portion 24 has a large amount of expansion flexibility.

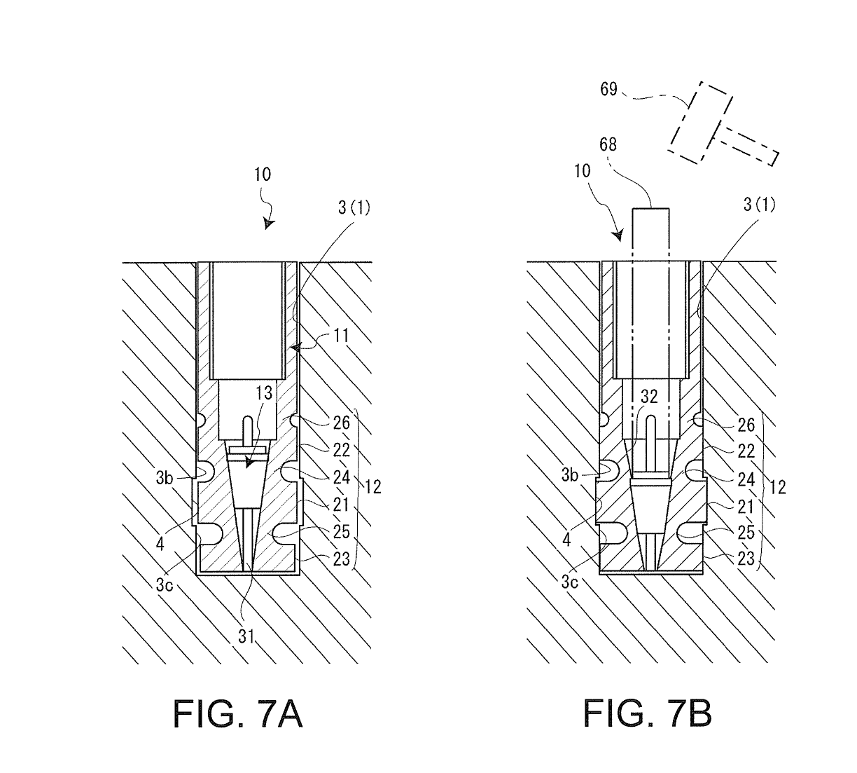

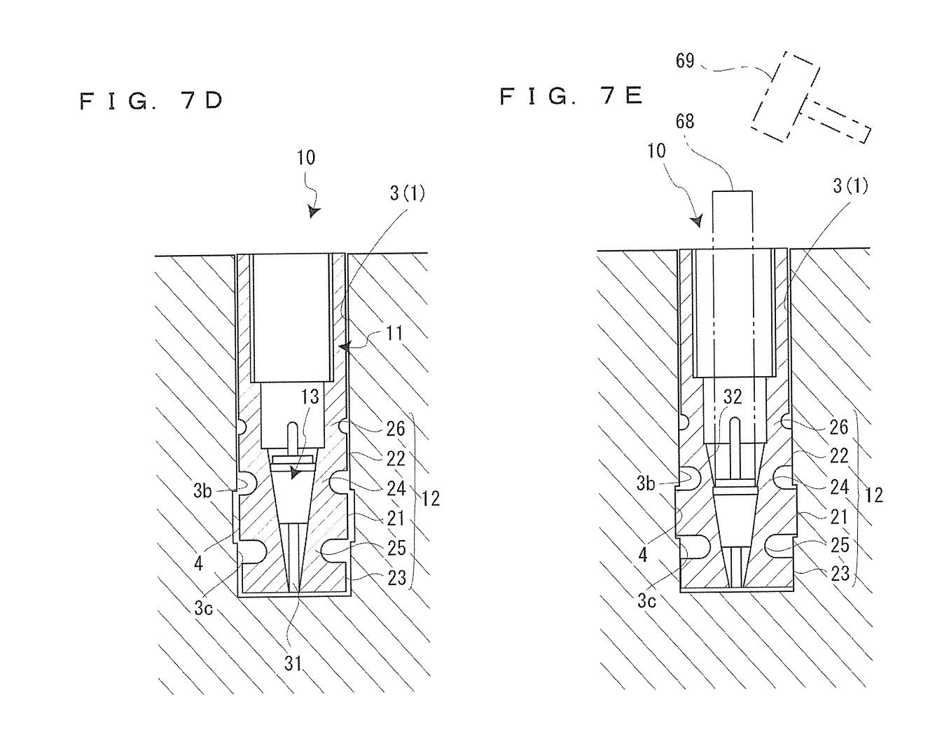

As explained above, the main expanding portion corresponds to the diameter expanded portion 4 of the anchor hole 1. Therefore, when the post-installed anchor is inserted in the anchor hole 1, the main expanding portion 21 faces the diameter expanded portion 4, the base side expanding portion 22 faces the opening side hole portion 3b near the diameter expanded portion 4, and the tip side expanding portion 23 faces the bottom side hole portion 3c near the diameter expanded portion 4 (see FIG. 7D). In this state, when the cone portion 13 is struck, the cone portion 13 moves to a position mainly at the main expanding portion 21. Thus, the expanding force acts on the diameter expanding portion 12 centering around the main expanding portion 21, and the sub thin-walled portion 26, the base side thin-walled portion 24 and the tip side thin-walled portion 25 deform accordingly. Therefore, the diameter expanding portion 12 deforms to a shape along the anchor hole 1.

Specifically, the base side expanding portion 22 deforms along the opening side hole portion 3b near the diameter expanded portion 4, the main expanding portion deforms along the diameter expanded portion 4 and the tip side expanding portion 23 deforms along the bottom side hole portion 3c near the diameter expanded portion 4. In other words, the base side expanding portion 22 is pressed to contact on the opening side hole portion 3b, the main expanding portion 21 is pressed to contact on the diameter expanded portion 4 and the tip side expanding portion 23 is pressed to contact on the bottom side hole portion 3c (see FIG. 7E).

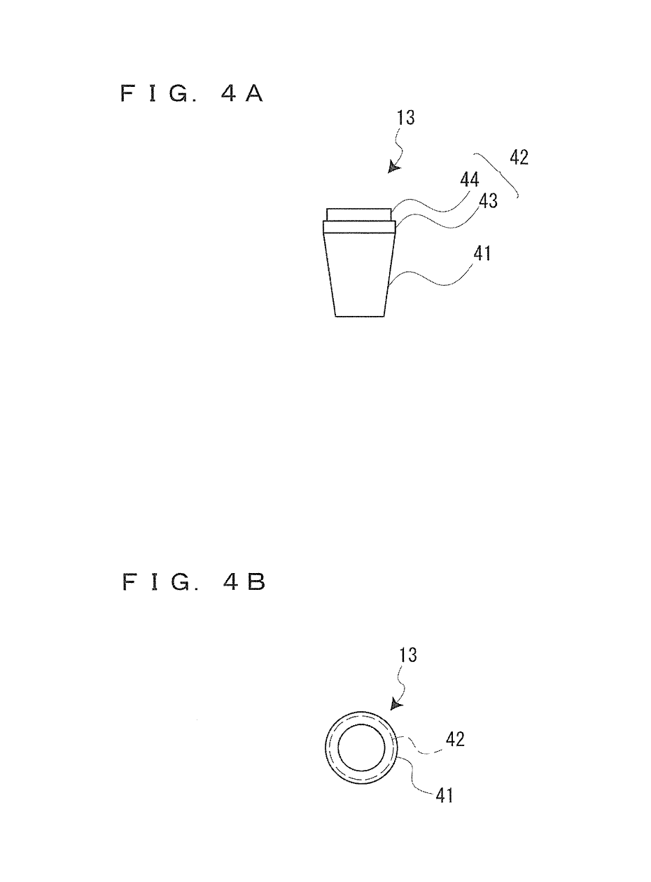

As illustrated in FIG. 3 to FIG. 4B, the cone portion 13 has a tapered portion 41 constituting a main body and a driven portion 42 continuing to a base side of the tapered portion 41. Length of the tapered portion 41 contacting on the cone reception portion 32 corresponds to length of the main expanding portion 21. Shortly, the tapered portion 41 preferably has an approximately same length as the main expanding portion 21. Length of the cone portion 13 of the embodiment is formed in size “9” between “6” and “12” in the above size ratio. The cone portion 13 is designed to have a size to be driven to the position at the main expanding portion 21 (see FIG. 7E).

The tapered portion 41 is formed in a tapered shape (frustum shape) tapering off to a tip and is formed at a same taper angle as the cone reception portion 32 as explained above. Thus, the diameter expanding portion 12 (main expanding portion 21) expands to translate outwardly.

The driven portion 42 is a portion on which a driving pin 68 explained later butts. The driven portion has a straight portion 43 which continues to a base side of the tapered portion 41 and has a same diameter as a base side of the tapered portion 41, and a small diameter portion 44 which continues to the straight portion 43 and has a smaller diameter than the straight portion 43. As explained above, the cone portion 13 is driven to the position at the main expanding portion 21 on design, and reaction force by pressure contact of the base side expanding portion 22 acts to embrace the base side of the cone portion 13 at this moment.

Therefore, the inner peripheral surface of the base side expanding portion 22 (substantially, the inner peripheral surface of the base side thin-walled portion 24) slightly deforms along the shapes of the straight portion 43 and the small diameter portion 44. This prevents the driven cone portion 13 from falling off because a stepped portion between the straight portion 43 and the small diameter portion 44 functions as a stop (see FIG. 7E). In a product state, it is preferable that the cone portion 13 be fixed to be lightly driven in the cone reception portion 32 or be adhered in the cone reception portion 32 by an adhesive.

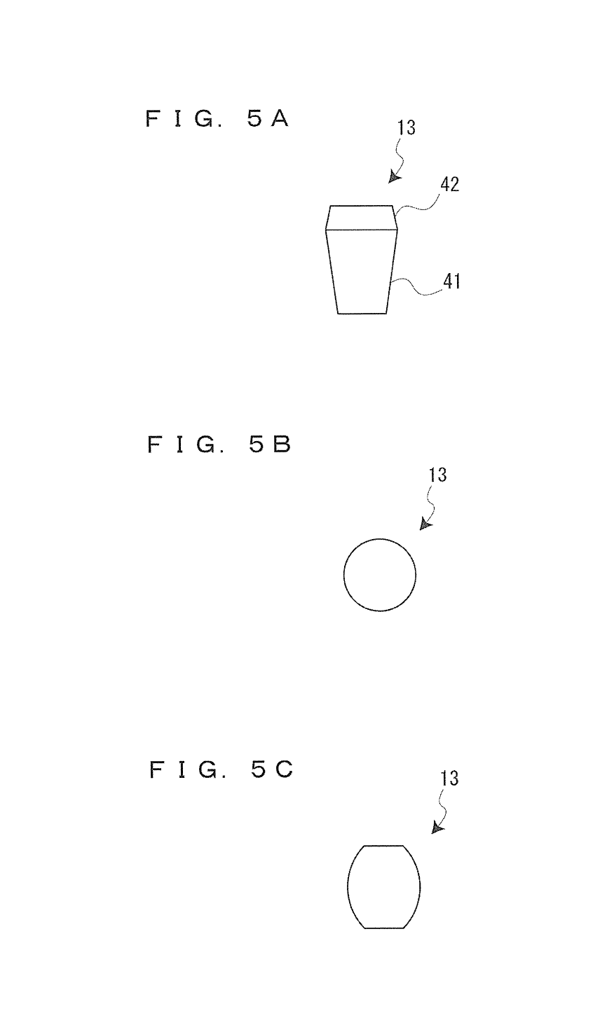

Next, referring to FIGS. 5A to 5C, a modification of the cone portion 13 will be explained. Of the cone portion 13 illustrated in FIG. 5A, the driven portion (inverse tapered portion) 42 is formed in a tapered shape tapering off to a base. Shortly, the driven portion 42 is formed in an inverse tapered shape with respect to the tapered portion 41. Also in this case, the inner peripheral surface of the base side expanding portion 22 (substantially, the inner peripheral surface of the base side thin-walled portion 24) slightly deforms along a shape of the driven portion 42, which prevents the cone portion 13 from falling off.

On the other hand, the cone portion 13 in FIG. 5B is formed in a spherical shape and the cone portion 13 in FIG. 5C is formed in a drum shape. Those cone portions 13 are also formed in a size to be struck to the position at the main diameter expanding portion 21. Also in this case, the diameter expanding portion 12 acts to embrace the struck cone portion 13, which prevents the cone portion 13 from falling off.

Next, referring to FIGS. 6A to 7E, an installation method (installation procedure) of the post-installed anchor 10 will be explained. The installation method includes a perforating process by which the prepared hole portion 3 is perforated by a perforating apparatus 51 (FIG. 6A), a diameter expanding process by which the diameter expanded portion 4 is formed in the prepared hole portion 3 by the diameter expanding apparatus 52 (FIG. 6B), an injecting process by which an adhesive A is injected in the anchor hole 1 by an injecting apparatus (FIG. 6C), an inserting process by which the post-installed anchor 10 is inserted to mount in the anchor hole 1 (FIG. 7D), and an anchoring process by which the diameter expanding portion 12 of the inserted post-installed anchor 10 is expanded (FIG. 7E).

The perforating apparatus 51 is made up of an electric drill (not illustrated) and a diamond core bit mounted thereon. The diamond core bit 55 has, for example, a cylindrical blade portion 56 and a shank portion 57 supporting the blade portion 56. The framework 2 is perforated to form the prepared hole portion 3 such that the blade portion 56 takes a core out of the concrete (see FIG. 6A). A diamond non-core bit may be used in place of the diamond core bit 55, or a vibration drill may be used for perforation.

The diameter expanding apparatus 52 is made up of the electric drill (not illustrated) and a diameter expanding drill bit 61 mounted thereon. The diameter expanding drill bit 61 has, for example, a pair of blade portions 62, a blade holding portion 63 which holds the pair of blade portions 62 movably in a radial direction and a shank portion 64 which supports the blade holding portion 63, and forms the diameter expanded portion 4 by expanding the pair of blade portions 62 with the assistance of the centrifugal force (rotation) in the radial direction (see FIG. 6B).

A size from a tip of the post-installed anchor (the tip of the tip side expanding portion 23) to an intermediate position of the main expanding portion 21 is designed as same as that from a tip of the diameter expanding drill bit 61 (a tip of the blade holding portion 63) to an intermediate position of the blade portions 62. Further, the blade portions 62 are formed longer than the main expanding portion 21. Shortly, the main expanding portion 21 of the post-installed anchor 10 which is anchored in the anchor hole 1 can be aligned with the diameter expanded portion 4 formed by the blade portions 62.

The injecting apparatus 53 has a pump section (not illustrated) and a nozzle section 66, the adhesive A stored in the pump section is discharged from a tip of the nozzle section 66 and is injected in the anchor hole 1 by pumping the pump section (see FIG. 6C).

In the perforating process illustrated in FIG. 6A, the diamond core bit 55 is rotated by the electric drill to form the prepared hole portion 3 having depth corresponding to length of the post-installed anchor 10. In this case, the diamond core bit 55 is used by which dimension (a diameter) of the prepared hole portion 3 is formed approximately around 0.5 mm wider than dimension (an outer diameter) of the post-installed anchor 10. In the diamond core bit 55, cooling liquid is supplied to the blade portion 56 via the shank portion 57.

In the diameter expanding process illustrated in FIG. 6B, the diameter expanding drill bit 61 is inserted in the prepared hole portion 3 to butt on the bottom thereof and is rotated by the electric drill to grind the diameter expanded portion 4. In the diameter expanding drill bit 61, the cooling liquid is also supplied to the pair of blade portions 62. Even after the diameter expanded portion 4 is formed, the cooling liquid continues to be supplied for a short time to cleanse the anchor hole 1. This makes cleaning for the anchor hole 1 prior to the injecting process unnecessary.

In the injecting process illustrated in FIG. 6C, the nozzle section 66 is inserted in the anchor hole 1 to butt on the bottom thereof and the adhesive A is injected from the innermost of the anchor hole 1. In this case, an epoxy resin adhesive is used as the adhesive A. Further, an injected amount of the adhesive A equals to an amount which is calculated by subtracting a volume of the post-installed anchor 10 from a volume of the anchor hole 1 (including the diameter expanded portion 4). This prevents the adhesive A from spreading out of the anchor hole 1 when the post-installed anchor 10 is inserted in the anchor hole 1.

In the inserting process illustrated in FIG. 7D, the post-installed anchor 10 is inserted in the anchor hole 1 to butt on the bottom thereof. This insertion allows the main expanding portion 21 of the post-installed anchor 10 to correspond to the diameter expanded portion 4 of the anchor hole 1.

In the anchoring process illustrated in FIG. 7E, a driving bar 68 is inserted in the cylindrical body 11 to contact on the cone portion 13 and the cone portion 13 is driven by a hammer 69 or the like via the driving bar 68. This pushes the cone portion 13 strongly in the diameter expanding portion 12 (the main expanding portion 21), and the base side expanding portion 22, the main expanding portion 21 and the tip side expanding portion constituting the diameter expanding portion 12 expand along the shape of the diameter expanded portion 4 in the anchor hole 1. This makes the base side expanding portion 22 be pressed to contact on the opening side hole portion 3b, the main expanding portion 21 be pressed to contact on the diameter expanded portion 4, and the tip side expanding portion 23 be pressed to contact on the bottom side hole portion 3c.

Thus, according to the post-installed anchor 10 of the first embodiment, the base side opening portion 22 is pressed to contact on the opening side hole portion 3b, the main expanding portion 21 is pressed to contact on the diameter expanded portion 4 and the tip side expanding portion 23 is pressed to contact on the bottom side hole portion 3c by striking the cone portion 13. Especially, the pressure contact of the base side expanding portion 22 and the tip side expanding portion on the prepared hole portion 3 prevents the chatter (wobble) of the post-installed anchor 10 and restrains looseness of the post-installed anchor 10 due to vibration or the like. Further, the pressure contact of the main expanding portion 21 on the diameter expanded portion 4 forms the stop on the circular stepped portions 5, leading to enhance the pullout strength of the post-installed anchor 10.

Further, since the main expanding portion 21 can expand widely caused by deformation of the base side thin-walled portion 24 and the tip side thin-walled portion 25, not only the main expanding portion 21 can properly be pressed to contact on the diameter expanded portion 4, but also the main expanding portion 21 can be formed to have a same diameter as the cylindrical body 11. Therefore, difference between the diameter of the prepared hole portion 3 in consideration of insertion of the post-installed anchor 10 and the diameter of the post-installed anchor 10 can be kept small (around 0.5 mm). In this regard, the installed post-installed anchor has a structure which is difficult to incur the chatter (wobble).

Moreover, the cone portion 13 can be also prevented from falling off due to vibration or the like by contriving the shape of the driven portion 42 of the cone portion 13 to take advantage that the diameter expanding portion 12 deforms (expands) along the shape of the diameter expanded portion 4. Therefore, not only the post-installed anchor 10 can be firmly fixed in the anchor hole 1, but also the chatter due to vibration or the like can be prevented, thereby the decrease of the pullout strength as time passes can be effectively prevented.

To ensure that the cone portion 13 is prevented from falling off, an internal thread may be formed in the above communication hole to be screwed with an external thread, or a gunmetal or a lump of lead (column-shaped or spherical) may be struck therein.

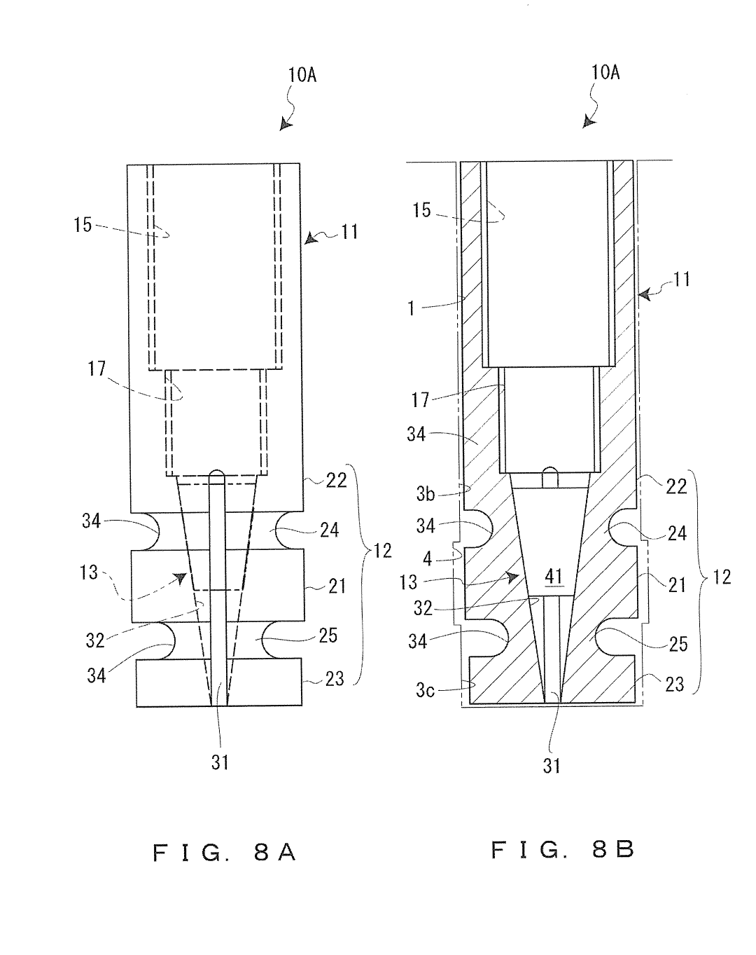

Next, referring to FIGS. 8A and 8B, a post-installed anchor 10A according to the second embodiment will be explained. The post-installed anchor 10A does not have the sub thin-walled portion 26 described above and the base side expanding portion 22 is consecutively connected with the cylindrical body 11 integrally. The four slits 31 extend to a position at the base side expanding portion 22. Therefore, when the cone portion is driven (also in this case, the cone portion 13 is driven to a position at the main expanding portion 21), the main expanding portion 21 sandwiched between the base side thin-walled portion 24 and the tip side thin-walled portion 25 is widely expanded while the base side expanding portion 22 and the tip side expanding portion are expanded a little. Shortly, the base side expanding portion 22 is pressed to contact on the opening side hole portion 3b, the main expanding portion 21 is pressed to contact on the diameter expanded portion 4 and the tip side expanding portion 23 is pressed to contact on the bottom side hole portion 3c.

While, the cone portion 13 is formed in a simple tapered shape tapering off to a tip and, also in this case, is formed to have a same taper angle as the cone reception portion 32. Further, an internal thread is formed in the communication hole 17 located between the cone reception portion 32 and the internal thread portion 15. Though not illustrated, a hexagon socket external thread is screwed in the communication hole 17 and the falling off of the cone portion 13 can be prevented by screwing the external thread in the communication hole 17 after the cone portion 13 is struck. Further, the gunmetal or the lump of lead (column-shaped or spherical) may be struck as explained above.

In the post-installed anchor 10A of the second embodiment, the chatter (wobble) of the post-installed anchor 10A can also be effectively prevented and the pullout strength of the post-installed anchor 10A can be enhanced by pressing to contact the main expanding portion 21 on the diameter expanded portion 4. Therefore, not only the post-installed anchor 10A can be firmly fixed, but also the chatter due to vibration or the like can be restrained, which can effectively avoid the decrease of the pullout strength as time passes.

In the above embodiments, though the invention applied to the internal cone driving type anchor is explained, the invention can also be applied to a mandrel driving type anchor and a clamping type anchor (a taper bolt type, a double cone nut type, a wedge type) of which expanding portion does not move in driving. Further, as long as the main expanding portion 12 can be widely expanded, a structure may be taken in which either one of the base side thin-walled portion and the tip side thin-walled portion is omitted.

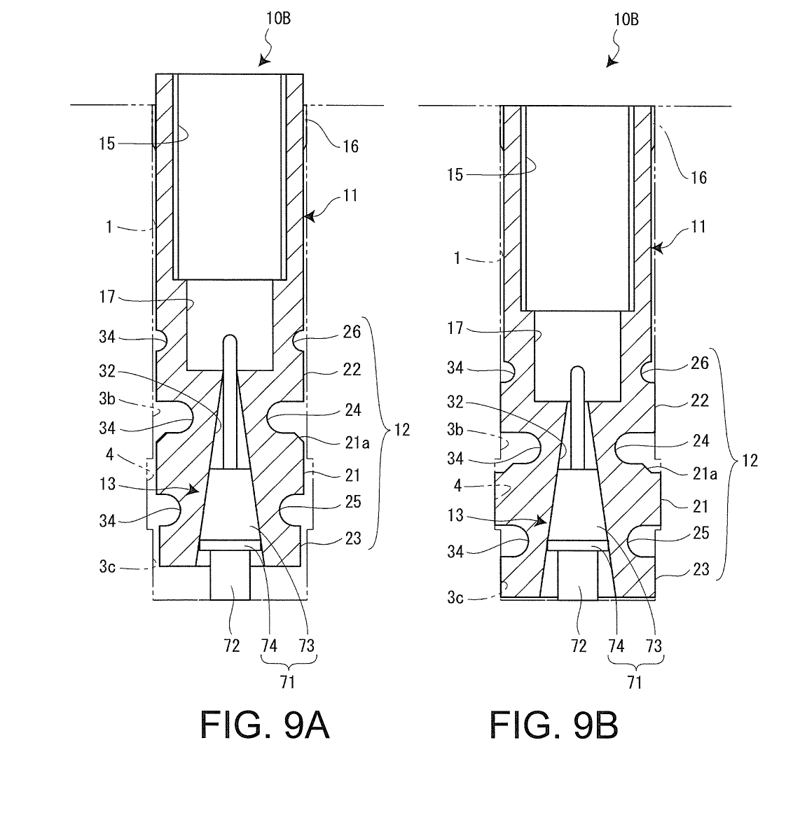

Next, referring to FIGS. 9A and 9B, a post-installed anchor 10B according to the third embodiment will be explained. The post-installed anchor 10B of the invention is applied to a main body driving type anchor. As illustrated in FIGS. 9A and 9B, the post-installed anchor 10B of the third embodiment has, as the post-installed anchor 10 of the first embodiment, the cylindrical body 11, the diameter expanding portion 12 and the cone portion 13 provided at a tip portion of the diameter expanding portion 12.

Likewise, the diameter expanding portion 12 has the main expanding portion 21, the base side expanding portion 22 and the tip side expanding portion 23. Further, the diameter expanding portion 12 has the base side thin-walled portion 24 (first deformation portion), the tip side thin-walled portion 25 (first deformation portion) and the sub thin-walled portion 26 (second deformation portion). In other words, the diameter expanding portion 12 has, from the cylindrical body 11 side, the sub thin-walled portion 26, the base side expanding portion 22, the base side thin-walled portion 24, the main expanding portion 21, the tip side thin-walled portion 25 and the tip side expanding portion 23 in that order. Further, the plurality of slits 31 are formed in the diameter expanding portion 12 cut from the tip thereof up to a position at the sub thin-walled portion 26.

In the inner peripheral surface of the diameter expanding portion 12, the cone reception portion 32 which is in an inverse tapered shape and tapers off to the base with respect to the cone reception portion 32 of the first embodiment is formed. The cone portion 13 is attached to a tip portion of the cone reception portion 32. By striking the cylindrical body 11 in a state that a base end of the cone portion 13 contacts on the bottom of the prepared hole portion 3, the cone portion 13 is struck relatively in the diameter expanding portion 12, which causes the diameter expanding portion 12 to expand.

Further in this case, the base side expanding portion 22 and the main expanding portion 21 are formed to have a same diameter as the cylindrical body 11. Also, the tip side expanding portion 23 is formed to have a slightly smaller diameter than the base side expanding portion 22 and the main expanding portion 21. Still further, the main expanding portion 21 is configured to correspond to a depth position at the diameter expanded portion 4 when the post-installed anchor 10B is anchored (driven). The tip side thin-walled portion 25, the base end thin-walled portion 24 and the sub thin-walled portion 26 deform by the expanding force of the cone portion 13 prior to the tip side expanding portion 23, the main expanding portion 21 and the base end expanding portion 22.

In other words, when the cylindrical body 11 is struck, the cone portion 13 relatively proceeds to a position at the main expanding portion 21. Thus, as the first embodiment, the expanding force acts on the diameter expanding portion 12 centering around the main expanding portion 21, and the sub thin-walled portion 26, the base side thin-walled portion 24 and the tip side thin-walled portion 25 deform appropriately. Therefore, the diameter expanding portion 12 deforms in a shape along the anchor hole 1. More specifically, the base side expanding portion 22 deforms along the opening side hole portion 3b near the diameter expanded portion 4, the main expanding portion 21 deforms along the diameter expanded portion 4, and the tip side expanding portion 23 deforms along the bottom side hole portion 3c near the diameter expanded portion 4. Shortly, the base side expanding portion 22 is pressed to contact on the opening side hole portion 3b, the main expanding portion 21 is pressed to contact on the diameter expanded portion 4, and the tip side expanding portion 23 is pressed to contact on the bottom side hole portion 3c (see FIG. 9B).

Each portion of the diameter expanding portion expands by driving such that each portion except the cone portion 13 advances in the anchor hole 1.

Therefore, in the diameter expanding portion 12, a chamfer 21a is formed at an end portion of the base side of the main expanding portion 21 so that the main expanding portion 21 is not stuck on the opening side hole portion 3b before the whole main expanding portion 21 is fit in the diameter expanded portion 4.

The cone portion 13 of the third embodiment has a fundamental form in which the cone portion 13 of the first embodiment is turned upside down. The cone portion has a cone portion main body 71 which expands the diameter expanding portion 12, and a butting portion 72 which continues to the cone portion main body 71, is formed to have a smaller diameter than a base side of the cone portion main body 71, and is butted on the bottom of the anchor hole 1. The butting portion 72 is formed in a column-shape and length thereof is designed such that the cone portion main body 71 is driven relatively to the position at the main expanding portion 21 when the cylindrical body 11 is struck (FIG. 9B).

The cone portion main body 71 has a tapered portion 73 which is formed in a tapered shape tapering off toward the cylindrical body 73 and a straight portion 74 which continues to a base side of the tapered portion 73 and has a same diameter as a base side of the tapered portion 73. Also in this case, length of the tapered portion 73 contacting on the cone reception portion 32 corresponds to length of the main expanding portion 21. Further, the cone portion 13 is designed in a size to be driven to the position at the main expanding portion 21 (see FIG. 9B).

As explained above, the cone portion 13 is configured to be struck to the position at the main expanding portion 21 on design, and the reaction force by pressure contact at the tip side expanding portion 23 acts to embrace the base side of the cone portion 13. Therefore, the inner peripheral surface of the tip side expanding portion 23 (practically, the inner peripheral surface of the tip side thin-walled portion 25) slightly deforms along the shape of the straight portion 74. Thus, the cone portion 13 is prevented from falling off (see FIG. 9B).

As the modification of the first embodiment, an inverse tapered portion which has an inverse tapered shape to the tapered portion 73 may be provided in place of the straight portion 74 of the cone portion main body 71. Further, the shape of the cone portion main body 71 may be spherical or drum shape.

As such, according to the post-installed anchor 10B of the third embodiment, as the first embodiment, the pressure contact of the base side expanding portion 22 and the tip side expanding portion 23 on the prepared hole portion 3 prevents chatter (wobble) of the post-installed anchor 10B and restrains looseness of the post-installed anchor 10B due to vibration or the like. Further, by pressing to contact the main expanding portion 21 on the diameter expanded portion 4, the main expanding portion 21 hangs up on the circular stepped portions 5, which enhances pullout strength of the post-installed anchor 10B.

Further, not only the main expanding portion 21 can press to contact on the diameter expanded portion 4 properly, but also can have a same diameter as the cylindrical body 11. Therefore, a difference between the diameter of the prepared hole portion 3 in consideration of the insertion of the post-installed anchor 10 and the diameter of the post-installed anchor 10B can make small (about 0.5 mm). Also in that point, the post-installed anchor 10B after construction can have a structure with little chatter (wobble).

Further, by utilizing that the diameter expanding portion 12 deforms (expands) along the shape of the diameter expanded portion 4 and contriving the shape of the cone portion main body, the cone portion 13 is prevented from falling off due to vibration or the like. Therefore, not only the post-installed anchor 10B can be firmly fixed in the anchor hole 1, but also the chatter due to vibration or the like can be restrained and the decrease of the pullout strength as time passes can be effectively prevented. It is noted that the invention can be applied to a sleeve driving anchor in which the diameter expanding portion 12 is move when the anchor is driven. Further, in the embodiment, as the diameter expanded portion 4 is formed by a cylindrical portion which projects outwardly from the prepared hole portion 3 having two circular stepped portions 5, but as long as the diameter expanded portion 4 has base side circular stepped portion 5, the shape thereof may be formed like a column shape, not exactly cylindrical shape.

### REFERENCE NUMERALS

1: anchor hole 2: framework 3: prepared hole portion 4: diameter expanded portion 10, 10A, 10B: post-installed anchor 11: cylindrical body 12: diameter expanding portion 13: cone portion 21: main expanding portion 22: base side expanding portion 23: tip side expanding portion 24: base side thin-walled portion 25: tip side thin-walled portion 26: sub thin-walled portion 32: cone reception portion 34: circular groove 41: tapered portion 42: driven portion 43: straight portion 44: small diameter portion 51: perforating apparatus 52: diameter expanding apparatus 53: injecting apparatus 61: diameter expanding drill bit 62: blade portion 71: cone portion main body 72: butting portion 73: tapered portion 74: straight portion A: adhesive

1. A post-installed anchor that is anchored in an anchor hole having a diameter expanded portion formed at a predetermined depth position in a prepared hole comprising:
a cylindrically-shaped cylindrical body that is inserted in the anchor hole;
a diameter expanding portion that continues to a tip side of the cylindrical body; and
a cone portion that expands the diameter expanding portion from an inside, the diameter expanding portion having:
a main expanding portion that corresponds to the diameter expanded portion;
a base side expanding portion that continues to a base side of the main expanding portion; and
a tip side expanding portion that continues to a tip side of the main expanding portion; and
a first deformation portion that is provided at least one of positions between the base side expanding portion and the main expanding portion and between the main expanding portion and the tip side expanding portion, and that deforms prior to the main expanding portion, the base side expanding portion and the tip side expanding portion when the diameter expanding portion is expanded by the cone portion.

2. The post-installed anchor according to claim 1, wherein the tip side expanding portion is formed to have a smaller diameter than the main expanding portion.

3. The post-installed anchor according to claim 2, wherein the base side expanding portion and the main expanding portion have a same diameter as the cylindrical body.

4. The post-installed anchor according to claim 1, wherein the first deformation portion is a thin-walled portion formed by a circular groove formed on an outer peripheral surface of the diameter expanding portion.

5. The post-installed anchor according to claim 1, wherein the first deformation portions are provided at two positions between the base side expanding portion and the main expanding portion and between the main expanding portion and the tip side expanding portion.

6. The post-installed anchor according to claim 5, wherein the first deformation portions at the two positions are formed to have same volume.

7. The post-installed anchor according to claim 5, wherein the diameter expanding portion further has a second deformation portion that is provided between the cylindrical body and the base side expanding portion and deforms prior to the cylindrical body and the base side expanding portion when the diameter expanding portion is expanded by the cone portion.

8. The post-installed anchor according to claim 7 further having a plurality of slits extending from a tip to the second deformation portion.

9. The post-installed anchor according to claim 7, wherein the post-installed anchor is a cone driving type where the cone portion is driven in the cylindrical body, an inner peripheral surface of the diameter expanding portion is formed in a tapered shape tapering off the tip, and the cone portion is formed in a size that is suitable for being driven to a position at the main expanding portion.

10. The post-installed anchor according to claim 9, wherein the cone portion has a tapered portion that is formed in a tapered shape tapering off to the tip and a straight portion that continues to a base side of the tapered portion and is formed to have a same diameter as a base side of the tapered portion.

11. The post-installed anchor according to claim 9, wherein the cone portion has a tapered portion that is formed in a tapered shape tapering off to the tip and an inverse tapered portion that continues to the base side of the tapered portion and is formed in a tapered shape tapering off to the base.

12. The post-installed anchor according to claim 9, wherein the cone portion is formed in either a spherical shape or a drum shape.

13. The post-installed anchor according to claim 7, wherein the post-installed anchor is a main body driving type where the cylindrical body is driven with respect to the cone portion, the cone portion has a cone portion main body that expands the diameter expanding portion and a struck portion that continues to the cone portion main body, is formed to have a smaller diameter than the cone portion main body, and is butted on a bottom of the anchor hole, an inner peripheral surface of the diameter expanding portion is formed in a tapered shape tapering off to a base, and the cone portion main body is formed in a size that is suitable for being driven to a position at the main expanding portion.

14. The post-installed anchor according to claim 13, wherein the cone portion main body has a tapered portion that is formed in a tapered shape tapering off toward the cylindrical body and a straight portion that continues to a base side of the tapered portion and has a same diameter as a base side of the tapered portion.

15. The post-installed anchor according to claim 13, wherein the cone portion main body has a tapered portion that is formed in a tapered shape tapering off toward the cylindrical body and an inverse tapered portion that continues to a base side of the tapered portion and is formed in a tapered shape tapering off to the base.

16. The post-installed anchor according to claim 13, wherein the cone portion main body is formed in either a spherical shape or a drum shape.

17. An installation method of the post-installed anchor according to claim 1 executing steps of:
perforating the prepared hole;
expanding to form the diameter expanded portion in the prepared hole;
inserting the post-installed anchor in the anchor hole; and
anchoring to expand the diameter expanding portion by the cone portion.

18. The installation method of the post-installed anchor according to claim 17 further executing a step of injecting an adhesive in the anchor hole between the expanding and the inserting.

19. A post-installed anchor system comprising:
the post-installed anchor according to claim 1; and
a diameter expanding drill bit that has a blade portion at a tip portion for grinding the anchor hole to grind the diameter expanded portion,
wherein, in the axial direction, the blade portion is formed longer than the main expanding portion, and a distance from a tip of the post-installed anchor to an intermediate position of the main expanding portion is set as same as a distance from a tip of the diameter expanding drill bit to an intermediate position of the blade portion.
